(19) United States
(12) Patent Application Publication
(10) Pub. No.: US 2015/0149777 A1
(43) Pub. Date: May 28, 2015

(54) MOBILE TERMINAL, TERMINAL AND AUTHENTICATION METHOD USING SECURITY COOKIE

(71) Applicant: ELECTRONICS AND TELECOMMUNICATIONS RESEARCH INSTITUTE, Daejeon-city (KR)

(72) Inventors: Seung-Hyun KIM, Daejeon (KR); Seung-Hun JIN, Daejeon (KR); Jin-Man CHO, Daejeon (KR); Young-Seob CHO, Daejeon (KR); Sang-Rae CHO, Daejeon (KR); Dae-Seon CHOI, Daejeon (KR); Jong-Hyouk NOH, Daejeon (KR); Soo-Hyung KIM, Daejeon (KR); Seok-Hyun KIM, Daejeon (KR)

(73) Assignee: ELECTRONICS AND TELECOMMUNICATIONS RESEARCH INSTITUTE, Daejeon-city (KR)

(21) Appl. No.: 14/516,141

(22) Filed: Oct. 16, 2014

(30) Foreign Application Priority Data
Nov. 22, 2013 (KR) 10-2013-0142828

(51) Int. Cl. H04L 9/08; H04L 9/32

(52) U.S. Cl. CPC H04L 9/0819; H04L 9/3263; H04L 2209/24
USPC 713/169

(57) ABSTRACT

An authentication method including: transmitting, by a first terminal, a security cookie to a server and making an authentication request; transmitting, by the server, session information and the security cookie to a second terminal in response to the authentication request; verifying, by the second terminal, whether the security cookie has been encoded by a session key pre-stored in the second terminal; and performing, by the second terminal and the server, mutual authentication in the case in which the security cookie is encoded by the session key pre-stored in the second terminal is disclosed.

### CROSS REFERENCE TO RELATED APPLICATION

This application claims the benefit of Korean Patent Application No. 10-2013-0142828, filed on Nov. 22, 2013, which is hereby incorporated by reference in its entirety into this application.

### BACKGROUND OF THE INVENTION

1. Technical Field

The present invention relates to a mobile terminal, a terminal, and an authentication method using a security cookie.

2. Description of the Related Art

A cookie, a scheme in which a server stores state information and authentication information of a client therein, is a technology generalized in most of the Internet environments. However, a problem that an attack such as arbitrary search or falsification for contents of the cookie is made or a third party extracts and steals a cookie of a user's personal computer (PC) through a malicious code or network sniffing has occurred. In order to solve this problem, a number of methods for limiting an available period of cookie authentication or encoding and decoding the cookie itself have been suggested.

However, these methods may not deal with the case in which the third party steals the cookie to reuse the cookie within the available period. Although confidentiality and integrity of the cookie may be ensured through encoding and decoding, it is still difficult to deal with a problem that the cookie is reused, such that there is a security problem.

Recently, a method of identifying a user's computer using a security cookie and blocking a third party from reusing the security cookie has been demanded. In connection with this, Korean Patent Application Publication No. 10-2010-0108132 discloses a technology related to “Apparatus and Method for Security Management of Web Access.”

### SUMMARY OF THE INVENTION

Accordingly, the present invention has been made keeping in mind the above problems occurring in the conventional art, and an object of the present invention is to provide a terminal and a method of authenticating a user's computer using a security cookie and blocking a third party from reusing the security cookie.

In accordance with an aspect of the present invention, there is provided an authentication method including: transmitting, by a first terminal, a security cookie to a server and making an authentication request; transmitting, by the server, the security cookie to a second terminal in response to session information indicating that a user of the first terminal and a user of the second terminal are the same as each other; verifying, by the second terminal, whether the security cookie has been encoded by a session key pre-stored in the second terminal; and performing, by the second terminal and the server, mutual authentication in the case in which the security cookie is encoded by the session key pre-stored in the second terminal.

The security cookie may include identification information of the first terminal and a hash value capable of verifying the identification information.

The identification information may include an Internet protocol (IP) address of the first terminal or a user ID.

The hash value may be a value by which the identification information is hashed using the pre-stored session key.

The pre-stored session key may be a session key created by the server and the second terminal when the server and the second terminal perform mutual authentication in a previous transaction.

The performing, by the second terminal and the server, of the mutual authentication may be based on authentication information that the second terminal and the server pre-share with each other.

The authentication information may be a user ID, a password, or a public key infrastructure.

The authentication method may further include setting, by the server, a new security cookie using a new session key when the mutual authentication succeeds.

The authentication method may further include transmitting, by the server, the new security cookie together with an authentication result to the first terminal.

In accordance with another aspect of the present invention, there is provided a first terminal including: a security cookie storing unit configured to store a security cookie therein; and an authentication requesting unit configured to transmit the security cookie to a server and make a request for authentication, wherein the authentication requesting unit receives an authentication result from the server in the case in which the security cookie is encoded by a session key stored in a second terminal, such that mutual authentication between the server and the second terminal is performed.

The authentication requesting unit may receive a security cookie newly created by the server and the second terminal, together with the authentication result, after the mutual authentication.

In accordance with still another aspect of the present invention, there is provided a second terminal including: a second terminal identification information managing unit configured to store a session key therein; a second terminal mutual authentication processing unit configured to receive a security cookie corresponding to session information indicating that a user of a first terminal and a user of the second terminal are the same as each other, from a server; and a security cookie verifying unit configured to verify whether the security cookie has been encoded by the session key, wherein the second terminal mutual authentication processing unit performs mutual authentication in the case in which the security cookie is encoded by the session key.

The session key may be a session key created by the server and the second terminal when the server and the second terminal perform mutual authentication in a previous transaction.

The second terminal mutual authentication processing unit may be based on authentication information.

The authentication information may be a user ID, a password, or a public key infrastructure.

The security cookie may include identification information of the first terminal and a hash value capable of verifying the identification information.

The identification information may include an IP address of the first terminal or the user ID.

The hash value may be a value by which the identification information is hashed using the session key.

The second terminal may further include a second terminal session information communicating unit configured to transmit or receive a link on the session information based on a personal identification number (PIN), a text, or a quick response (QR) code.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an authentication system according to an embodiment of the present invention;

FIG. 2 is a block diagram of a first terminal according to an embodiment of the present invention;

FIG. 3 is a block diagram of a server according to an embodiment of the present invention;

FIG. 4 is a block diagram of a second terminal according to an embodiment of the present invention; and

FIG. 5 is a ladder diagram of an authentication method according to an embodiment of the present invention.

### DESCRIPTION OF THE PREFERRED EMBODIMENTS

Hereinafter, embodiments of the present invention will be described in detail with reference to the accompanying drawings so that those skilled in the art may easily practice the present invention. However, the present invention may be modified in various different ways and is not limited to embodiments provided in the present description. In the accompanying drawings, portions unrelated to the description will be omitted in order to obviously describe the present invention, and similar reference numerals will be used to describe similar portions throughout the present specification.

Through the present specification and claims, unless explicitly described otherwise, “comprising” any components will be understood to imply the inclusion of other components rather than the exclusion of any other components.

In addition, throughout the present specification, when any one part is referred to as being “connected to” another part, it means that any one part and another part are “directly connected to” each other or are “electrically connected to” each other with the other part interposed therebetween.

Combinations of each block of the accompanying block diagram and each step of the accompanying flow chart may also be performed by computer program instructions. Since these computer program instructions may be mounted in a processor of a general computer, a special computer, or other programmable data processing apparatuses, these computer program instructions executed through the process of the computer or the other programmable data processing apparatuses create means performing functions described in each block of the block diagram or each step of the flow chart. Since these computer program instructions may also be stored in a computer usable or computer readable memory of a computer or other programmable data processing apparatuses in order to implement the functions in a specific scheme, the computer program instructions stored in the computer usable or computer readable memory may also produce manufacturing articles including instruction means performing the functions described in each block of the block diagram or each step of the flow chart. Since the computer program instructions may also be mounted on the computer or the other programmable data processing apparatuses, the instructions performing a series of operation steps on the computer or the other programmable data processing apparatuses to create processes executed by the computer, thereby executing the computer or the other programmable data processing apparatuses may also provide steps for performing the functions described in each block of the block diagram or each step of the flow chart.

In addition, each block or each step may indicate some of modules, segments, or codes including one or more executable instructions for executing a specific logical function (specific logical functions). Further, it is to be noted that functions mentioned in the blocks or the steps occur regardless of a sequence in some alternative embodiments. For example, two blocks or steps that are continuously shown may be simultaneously performed in fact or be performed in a reverse sequence depending on corresponding functions.

Hereinafter, an authentication method according to an embodiment of the present invention will be described in detail with reference to the accompanying drawings.

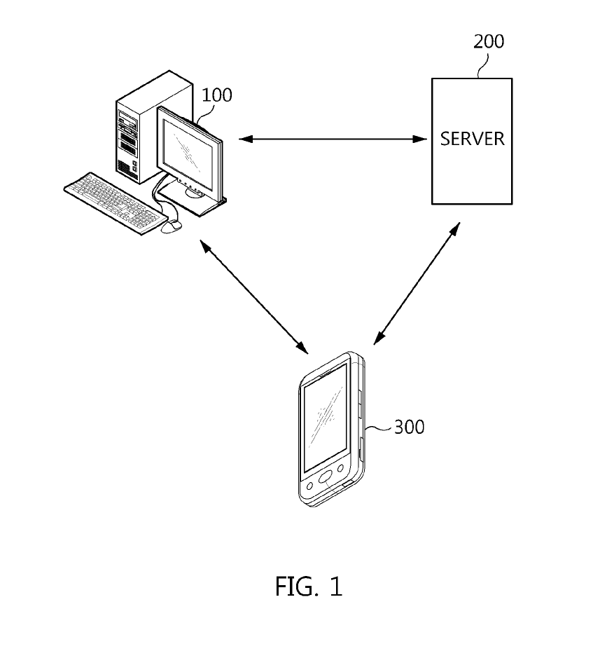

FIG. 1 is a diagram showing an authentication system according to an embodiment of the present invention.

The authentication system according to an embodiment of the present invention is configured to include a first terminal 100, a server 200, and a second terminal 300. According to an embodiment of the present invention, the first terminal 100 is a terminal that is to access the server 200. The first terminal 100 according to an embodiment of the present invention may be any one of a laptop computer, a terminal for digital broadcasting, a personal digital assistants (PDA), a portable multimedia player (PMP), a navigation device, a cellular phone, a smart phone, a digital television (TV), and a desktop computer. However, the present invention is not limited thereto, but may be applied as long as the first terminal 100 is a device that may access any web site provided by the server 200. The first terminal 100 according to an embodiment of the present invention may include a web browser or execute the web browser. However, the present invention is not limited thereto.

The server 200 receives a security cookie from the first terminal 100 and performs verification and mutual authentication of the security cookie through the second terminal 300. The server 200 provides a web site. In addition, the server 200 may also be described as the web site. However, the present invention is not limited thereto.

Hereinafter, the case in which the terminal 100 executes an application program or a web browser accessing the web site provided by the server 200 will be described by way of example.

The second terminal 300 may be any one of a laptop computer, a terminal for digital broadcasting, a PDA, a PMP, a navigation device, a cellular phone, a smart phone, a digital TV, and a desktop computer. However, the present invention is not limited thereto.

The second terminal 300 according to an embodiment of the present invention verifies the security cookie through a session key that it pre-shares with the server 200 to perform truth ascertainment of the first terminal 100. In addition, the second terminal 300 performs mutual authentication with the server 200. According to the present specification, the truth ascertainment of the first terminal 100 is to ascertain that the security cookie transmitted to the server is based on the first terminal 100.

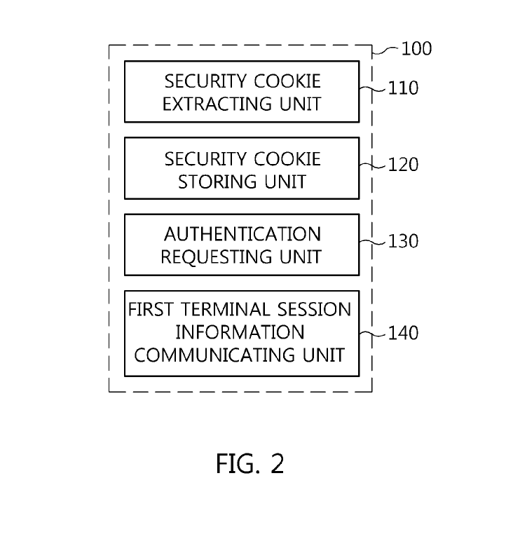

Next, the respective components of the first terminal 100, the server 200, and the second terminal 300 will be described with reference to FIGS. 2 to 4.

FIG. 2 is a block diagram of a first terminal according to an embodiment of the present invention.

Referring to FIG. 2, the first terminal 100 is configured to include a security cookie extracting unit 110, a security cookie storing unit 120, an authentication requesting unit 130, and a first terminal session information communicating unit 140. However, the components shown in FIG. 2 are not essential components. Therefore, the first terminal 100 having components more or less than the components shown in FIG. 2 may also be implemented.

The security cookie extracting unit 110 loads a stored security cookie. The security cookie extracting unit 110 according to an embodiment of the present invention loads a security cookie matched to the server 200 in the case in which the server 200 hosting the web site normally establishes a communication channel (for example, a hyper text transfer protocol (HTTP) or a hyper text transfer protocol over secure socket layer (HTTPS).

The security cookie according to an embodiment of the present invention includes identification information such as an Internet protocol (IP) address of the first terminal 100 or ID information of a user and a hash value that may verify the identification information.

In addition, the hash value of the security cookie is a value by which the identification information of the first terminal 100 is hashed using a session key created when the server 200 and the second terminal 300 perform mutual authentication in the previous transaction.

The security cookie storing unit 120 stores the security cookie therein. According to an embodiment of the present invention, the security cookie extracting unit 110 loads the security cookie stored in the security cookie storing unit 120. In addition, the security cookie storing unit 120 stores a new security cookie transferred by the server 200 after the authentication is completed. In addition, the security cookie storing unit 120 stores a security cookie received together with authentication result therein when the authentication requesting unit 130 receives the authentication result from the server 200.

The authentication requesting unit 130 transmits first information to the server 200. According to an embodiment of the present invention, the first information includes an authentication request signal (s1) and the security cookie extracted by the security cookie extracting unit 110. The authentication requesting unit 130 according to an embodiment of the present invention receives an authentication completion result from the server 200. In addition, the security cookie according to an embodiment of the present invention may also include identification information.

The first terminal session information communicating unit 140 receives link information of the server 200 and transfers the link information to the second terminal 300. The first terminal session information communicating unit 140 may also transmit and receive session information to and from the second terminal 300 based on a personal identification number (PIN), a text, a quick response (QR) code, or the like. The first terminal session information communicating unit 140 according to an embodiment of the present invention may transmit or receive a session information link based on the PIN, the text, and the QR code, or the like. However, the present invention is not limited thereto. The first terminal session information communicating unit 140 according to an embodiment of the present invention may transmit and receive the session information to and from the second terminal 300 in any other forms.

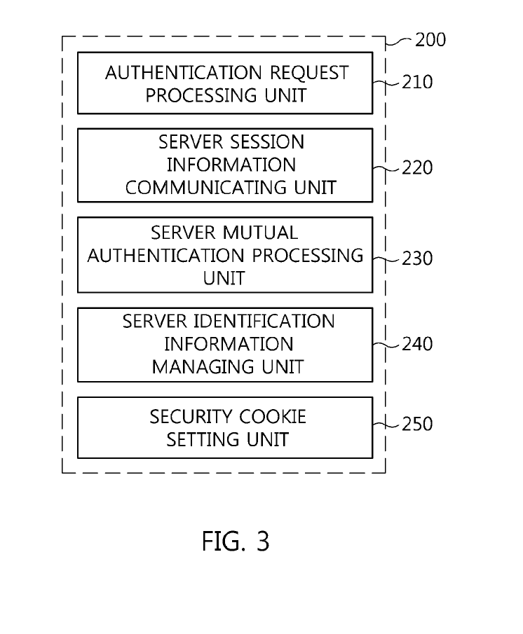

FIG. 3 is a block diagram of a server according to an embodiment of the present invention.

Referring to FIG. 3, the server 200 is configured to include an authentication request processing unit 210, a server session information communicating unit 220, a server mutual authentication processing unit 230, a server identification information managing unit 240, and a security cookie setting unit 250. However, the components shown in FIG. 3 are not essential components. Therefore, the server 200 having components more or less than the components shown in FIG. 3 may also be implemented.

The authentication request processing unit 210 receives the first information. That is, the authentication request processing unit 210 receives an authentication request for the web site and the security cookie when the request signal (s1) is input. In addition, the authentication request processing unit 210 transmits an authentication result together with a new security cookie to the first terminal 100.

The server session information communicating unit 220 transmits and receives the session information to and from the first terminal 100 based on the PIN, the text, the QR code, or the like. The server session information communicating unit 220 according to an embodiment of the present invention may transmit or receive the session information link based on the PIN, the text, and the QR code, or the like. However, the present invention is not limited thereto. The server session information communicating unit 220 according to an embodiment of the present invention may transmit and receive the session information to and from the first terminal 100 or the second terminal 300 in any other forms.

The server session information communicating unit 220 according to an embodiment of the present invention transfers the session information for processing a corresponding authentication request to the first terminal 100 and receives the session information from the second terminal 300.

The server mutual authentication processing unit 230 performs the mutual authentication with the second terminal 300. According to an embodiment of the present invention, the server mutual authentication processing unit 230 may also provide second information to the second terminal 300. The second information according to an embodiment of the present invention may also include a security cookie and information on the server 200. The security cookie may include identification information in which any one of a type of the web browser and the IP address of the first terminal 100 is included. In addition, the identification information according to an embodiment of the present invention may include another kind of information that may identify the first terminal 100. Further, the information on the server 200 may also include an address of the server and a unique number of the server. However, the present invention is not limited thereto.

The server identification information managing unit 240 stores the first information transferred by the first terminal 100 accessing the web site therein. The server identification information managing unit 240 according to an embodiment of the present invention may store the identification information therein.

The security cookie setting unit 250 creates a session key in the case in which the mutual authentication is successfully performed and sets a new security cookie using the created session key.

The security cookie setting unit 250 updates identification information such as an IP address received from the first terminal 100 and the ID information of the user in the security cookie. In addition, the security cookie setting unit 250 may also allow the hash value that may verify the identification information to be included in the security cookie.

In addition, the hash value of the security cookie is a value by which the identification information of the first terminal 100 is hashed using a session key created when the server 200 and the second terminal 300 perform the mutual authentication in a current transaction.

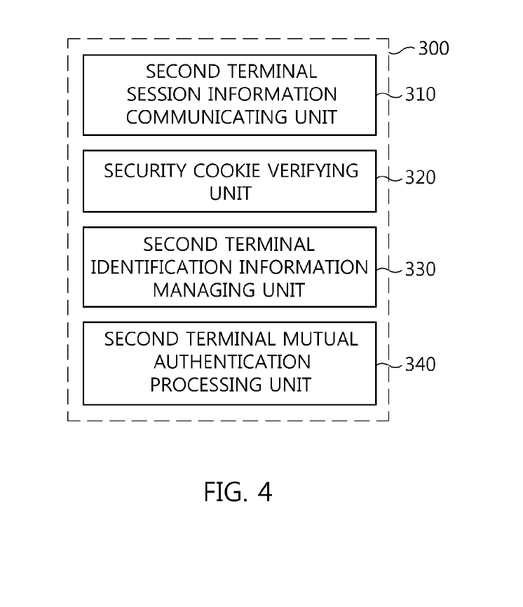

FIG. 4 is a block diagram of a second terminal according to an embodiment of the present invention.

Referring to FIG. 4, the second terminal 300 is configured to include a second terminal session information communicating unit 310, a security cookie verifying unit 320, a second terminal identification information managing unit 330, and a second terminal mutual authentication processing unit 340. However, the components shown in FIG. 4 are not essential components. Therefore, the second terminal 300 having components more or less than the components shown in FIG. 4 may also be implemented.

The second terminal session information communicating unit 310 receives the session information from the first terminal 100.

The security cookie verifying unit 320 verifies whether a security cookie is a security cookie encoded through a session key in the previous transaction.

The second terminal identification information managing unit 330 stores identification information such as the session key used in the previous transaction, a user ID, an IP of a user's computer, and the like, therein. In addition, the second terminal identification information managing unit 330 updates the identification information such as the session key, the user ID, the IP of the user's computer, and the like, after the mutual authentication.

The second terminal mutual authentication processing unit 340 performs the mutual authentication using authentication information that it pre-shares with the server 200. The pre-shared authentication information according to an embodiment of the present invention may be an ID, a password, or a public key infrastructure (PKI).

According to an embodiment of the present invention, when the security cookie verifying unit 320 makes a request for the session key and the identification information of the previous transaction, the second terminal identification information managing unit 330 transfers the session key and the identification information of the previous transaction to the security cookie verifying unit 320, stores the session key created by the second terminal mutual authentication processing unit 340 together with the identification information therein, and utilizes them in the next transaction.

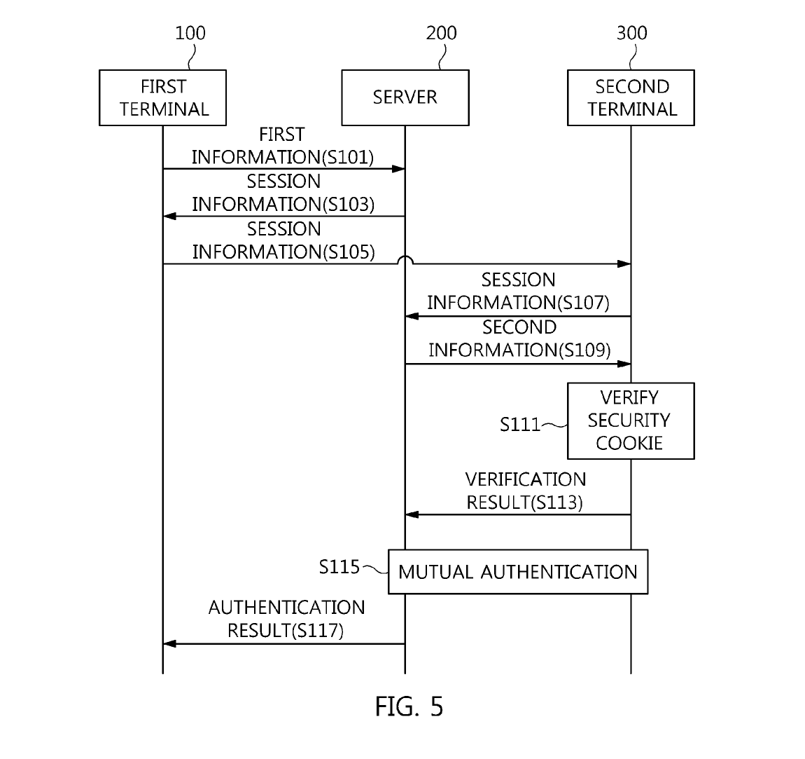

Next, an authentication method according to an embodiment of the present invention will be described with reference to FIG. 5.

FIG. 5 is a ladder diagram of an authentication method according to an embodiment of the present invention.

The authentication requesting unit 130 of the first terminal 100 transmits the first information to the server 200 (S101). The first information may be received by the authentication request processing unit 121 of the server 200. The first information according to an embodiment of the present invention includes the authentication request signal (s1) and the security cookie. The first information may include the security cookie extracted by the security cookie extracting unit 110 and the identification information on the first terminal 100.

The server session information communicating unit 220 transmits the session information to the first terminal 100 in response to the first information (S103). In this process, the session information may also be received by the first terminal session information communicating unit 140 of the first terminal 100. The session information according to an embodiment of the present invention may be information indicating that a user of the first terminal 100 and a user of the second terminal 300 are the same as each other.

The first terminal session information communicating unit 140 of the first terminal 100 transmits the received session information to the second terminal 300 (S105). In this process, the session information may also be received by the second terminal session information communicating unit 310 of the second terminal 300.

The second terminal session information communicating unit 310 of the second terminal 300 transmits the received session information to the server 200 (S107). In this process, the session information may also be received by the server session information communicating unit 220.

According to another embodiment of the present invention, the first terminal session information communicating unit 140 of the first terminal 100 may directly transmit the session information to the sever session information communicating unit 220, instead of S103 to S107. However, an embodiment of the present invention is not limited thereto. That is, the present invention may be applied even in the case in which the server session information communicating unit 220 receives the session information from apparatuses other than the first and second terminals 100 and 300.

The server mutual authentication processing unit 230 of the server 200 provides the second information to the second terminal mutual authentication processing unit 340 of the second terminal 300 (S109). The second information according to an embodiment of the present invention includes the security cookie and the server information.

The security cookie verifying unit 320 of the second terminal 300 verifies the security cookie based on the second information and the session key through which the security cookie is encoded in the previous transaction (S111). The security cookie verifying unit 320 of the second terminal 300 verifies whether the security cookie is the security cookie encoded through the session key in the previous transaction.

When it is verified that the security cookie is the security cookie encoded through the session key in the previous transaction, the second terminal mutual authentication processing unit 340 of the second terminal 300 transmits a verification result to the server mutual authentication processing unit 230 of the server 200 (S113).

The server mutual authentication processing unit 230 and the second terminal mutual authentication processing unit 340 perform the mutual authentication based on the pre-shared authentication information (S115). The pre-shared authentication information according to an embodiment of the present invention may be the ID, the password, or the PKI. In addition, the authentication information may be based on the session information. The security cookie setting unit 250 of the server 200 creates the session key in the case in which the mutual authentication is successfully performed and sets the new security cookie using the created session key. Further, in this case, the new session key is also created in the second terminal 300. In addition, according to still another embodiment of the present invention, in this process, the second terminal may also receive the session key created by the security cookie setting unit 250 of the server 200.

In addition, the authentication request processing unit 210 transmits the authentication result to the authentication requesting unit 130 of the first terminal (S117). In this case, the authentication request processing unit 210 may also transmit the newly set security cookie together with the authentication result.

In accordance with embodiments of the present invention, mutual authentication for any web site accessed by a user's computer is performed by a user's terminal, thereby making it possible to block an attack of a third party.

In accordance with embodiments of the present invention, the mutual authentication for any web site accessed by the user's computer is performed by the user's terminal, thereby making it possible to prevent authentication information such as an ID or a password from being exposed.

In accordance with embodiments of the present invention, the mutual authentication may be performed by the user's terminal, thereby making it possible to increase portability and utilization such as an N screen environment, or the like.

Although embodiments of the present invention have been described in detail hereinabove, the scope of the present invention is not limited thereto, but may include several modifications and alterations made by those skilled in the art using a basic concept of the present invention as defined in the claims.

What is claimed is:

1. An authentication method comprising:
transmitting, by a first terminal, a security cookie to a server and making an authentication request;
transmitting, by the server, the security cookie to a second terminal in response to session information indicating that a user of the first terminal and a user of the second terminal are the same as each other;
verifying, by the second terminal, whether the security cookie has been encoded by a session key pre-stored in the second terminal; and
performing, by the second terminal and the server, mutual authentication in the case in which the security cookie is encoded by the session key pre-stored in the second terminal.

2. The authentication method of claim 1, wherein the security cookie includes identification information of the first terminal and a hash value capable of verifying the identification information.

3. The authentication method of claim 2, wherein the identification information includes an Internet protocol (IP) address of the first terminal or a user ID.

4. The authentication method of claim 3, wherein the hash value is a value by which the identification information is hashed using the pre-stored session key.

5. The authentication method of claim 4, wherein the pre-stored session key is a session key created by the server and the second terminal when the server and the second terminal perform mutual authentication in a previous transaction.

6. The authentication method of claim 1, wherein the performing, by the second terminal and the server, of the mutual authentication is based on authentication information that the second terminal and the server pre-share with each other.

7. The authentication method of claim 6, wherein the authentication information is a user ID, a password, or a public key infrastructure.

8. The authentication method of claim 7, further comprising setting, by the server, a new security cookie using a new session key when the mutual authentication succeeds.

9. The authentication method of claim 8, further comprising transmitting, by the server, the new security cookie together with an authentication result to the first terminal.

10. A first terminal comprising:
a security cookie storing unit configured to store a security cookie therein; and
an authentication requesting unit configured to transmit the security cookie to a server and make a request for authentication,
wherein the authentication requesting unit receives an authentication result from the server in the case in which the security cookie is encoded by a session key stored in a second terminal, such that mutual authentication between the server and the second terminal is performed.

11. The first terminal of claim 10, wherein the authentication requesting unit receives a security cookie newly created by the server and the second terminal, together with the authentication result, after the mutual authentication.

12. A second terminal comprising:
a second terminal identification information managing unit configured to store a session key therein;
a second terminal mutual authentication processing unit configured to receive a security cookie corresponding to session information indicating that a user of a first terminal and a user of the second terminal are the same as each other, from a server; and
a security cookie verifying unit configured to verify whether the security cookie has been encoded by the session key,
wherein the second terminal mutual authentication processing unit performs mutual authentication in the case in which the security cookie is encoded by the session key.

13. The second terminal of claim 12, wherein the session key is a session key created by the server and the second terminal when the server and the second terminal perform mutual authentication in a previous transaction.

14. The second terminal of claim 13, wherein the second terminal mutual authentication processing unit performs the mutual authentication based on authentication information.

15. The second terminal of claim 14, wherein the authentication information is a user ID, a password, or a public key infrastructure.

16. The second terminal of claim 15, wherein the security cookie includes identification information of the first terminal and a hash value capable of verifying the identification information.

17. The second terminal of claim 16, wherein the identification information includes an IP address of the first terminal or the user ID.

18. The second terminal of claim 17, wherein the hash value is a value by which the identification information is hashed using the session key.

19. The second terminal of claim 12, further comprising a second terminal session information communicating unit configured to transmit or receive a link on the session information based on a personal identification number (PIN), a text, or a quick response (QR) code.
